(19) United States
(12) Patent Application Publication
(10) Pub. No.: US 2010/0158495 A1
(43) Pub. Date: Jun. 24, 2010

(54) AUTOFOCUS ASSIST LIGHTING USED FOR RANGEFINDING IN VERY LOW LIGHT CONDITIONS

(76) Inventor: John P. Spence, Webster, NY (US)

Correspondence Address: EASTMAN KODAK COMPANY;PATENT LEGAL STAFF, 343 STATE STREET, ROCHESTER, NY, 14650-2201, US

(21) Appl. No.: 12/544,247

(22) Filed: Aug. 20, 2009

Related U.S. Application Data
(60) Provisional application No. 61/139,726, filed on Dec. 22, 2008.

(51) Int. Cl. G03B 13/00

(52) U.S. Cl. 396/106

(57) ABSTRACT

Autofocus (AF) assist lighting can be useful as a camera rangefinder in low light conditions. When ambient light conditions are inadequate for determining camera-to-subject distance using through-the-lens autofocus (TTL-AF) procedures, the AF assist light is used to attempt to raise the light level enough that the camera-to-subject distance can be determined using TTL-AF. If a camera-to-subject distance is not determined when the AF assist light is used, a camera-to-subject distance based on tabulated values is determined using an empirical model of AF assist luminance increment versus distance. If a camera-to-subject distance can be determined using TTL-AF when the AF assist light is used, but the lighting conditions are inadequate, the camera-to-subject distance used for capturing an image is a weighted combination of the TTL-AF camera-to-subject distance and a camera-to-subject distance based on a set of tabulated values determined using an empircal model of AP assist luminance increment versus distance.

### CROSS-REFERENCE TO RELATED APPLICATIONS

This application claims the benefit of U.S. Provisional Application 61/139,726 filed on Dec. 22, 2008, which is hereby incorporated by reference.

### TECHNICAL FIELD

This invention relates to autofocus (AF) technology in digital cameras.

### BACKGROUND

AF systems, including through-the-lens autofocus systems (TTL-AF) can fail for a number of reasons. Even when an AF system fails to provide a reliable rangefinding result for camera-to-subject distance, a value needs to be supplied for use in setting lens focus position and for other purposes, such as setting flash power, aperture, or other distance-related capture parameters.

AF assist lighting (which may be in the form of light-emitting diodes (LEDs) or infrared (IR) lighting or any other suitable source) is often provided to address low-signal-level related failures. However, AF assist lighting enables a TTL-AF to provide a highly reliable AF in low ambient-light settings only at close camera-to-subject distances, and in very low ambient-light settings only at very close camera-to-subject distances.

If a low level of scene luminance results even with AF assist lighting activated so that TTL-AF rangefinder results cannot be trusted or that the AF process is not worth completing, some focus distance still needs to be assigned. In the absence of reliable distance information, various strategies have been employed. For example, setting a lens to its hyperfocal distance is a common strategy. This strategy can fail if subjects are too far to be illuminated by the focus-assist light but are also too close to be within the hyperfocal depth of field; in such a case, they may be well illuminated by the camera's flash, but will be poorly focused. If, on the other extreme, the lens focus distance is set at a closer distance to include a distance at which the focus-assist light barely provides adequate illumination in a dark setting, then more distant objects will be poorly focused, and potentially underexposed, if flash power is set to too low a level using this distance information.

There are other known issues with TTL-AF systems. For instance, AF on a subject with insufficient focusable detail may result in no focus position being found even if the AF assist light would have provided adequate illumination if the subjects had adequate focusable detail. In addition, an AF process can be aborted by the camera's user by way of activating the capture process prior to AF completion; this may also result in no reliable focus distance being generated. And it is also known that AF reliability is not a zero-one process; it varies between high reliability at higher light levels and low reliability at lower light levels.

One previous effort at solving the problem of using AF in low-light situations has involved using an AF assist light that projects a pattern such as a grid or set of bright lines onto the subject allowing AF convergence in the absence of focusable detail. Although these type of methods may provide some additional reliability in lower light situations, they are complex and, as a result, relatively costly.

Other previous solutions have also been unsatisfactory. Some of these include solely relying on a photodiode/photodetector as a rangefinder without even using a TTL-AF method; refusal to capture a photo when AF does not provide a reliable solution; and the use of TTL-AF results regardless of reliability.

### SUMMARY

It has been determined that an increase in scene luminance provided by the AF assist light can be detected and used to provide a camera-to-subject or focus distance estimate and thereby function as a backup rangefinder, even if it does not provide enough light to meaningfully assist TTL-AF or even if the AF process is prematurely aborted or unsuccessful. It has also been determined that this estimate may be used to set a focus distance when the TTL-AF is completely unreliable and to modify a TTL-AF result depending on the relative reliability of the AF assist light rangefinder result and the TTL-AF rangefinder result.

For example, it has been found on the Motorola ZN5 camera-phone that a scene luminance level that results in a detected focal plane illuminance of 5200 units is required to provide enough light for a highly reliable AF without focus-assist lighting. It is noted that the “units” of illuminance presented herein are determined for a particular imaging system and are not necessarily directly linked to a particular absolute light-intensity level such as lux; however, it is the relative magnitudes of these illuminance levels that is of relevance. Therefore, any suitable illumination measurement for any suitable imaging system may be used. When activated, an AF assist light in this camera-phone typically results in an incremental detected focal plane illuminance of at least 2400 units for average scenes in a macro focus distance range below 40 cm. As an example, a typical AF assist light may provide additional scene luminance to provide an incremental detected illuminance of 2400 units from an 18% spectrally non-selective diffuse reflector at a distance of 39 cm and the incremental detected illuminance follows a power law in distance with an exponent between −1 and −2 for distances beyond 40 cm.

A power law model relating incremental detected illuminance I and inferred camera-to-subject distance d is set forth below:

d=d₀(I/I₀)^{P}

Based on this formula, a table generated using d₀=39 cm, I₀=2400, and p=−1.6 is set forth below:

| | Subject distance |
|---|---|
| Delta Illum. | (cm) |
| 0 | 207 |
| 265 | 150 |
| 400 | 115 |
| 530 | 98 |
| 700 | 83 |
| 860 | 73 |
| 1050 | 65 |
| 1250 | 58 |
| 1450 | 53 |
| 1650 | 49 |
| 1900 | 45 |
| 2150 | 42 |
| 2400 | 39 |

These increment values are found to be valid for a wide range of ambient light levels whenever the AF assist light is used. Of course, any suitable power-law expression may be used, and the variables may also be modified for particular imaging systems, illumination levels, and subject distance.

### BRIEF DESCRIPTION OF THE DRAWINGS

FIGS. 1 and 2 illustrate a flowchart that demonstrates a process for using the AF assist light as a rangefinder.

### DETAILED DESCRIPTION

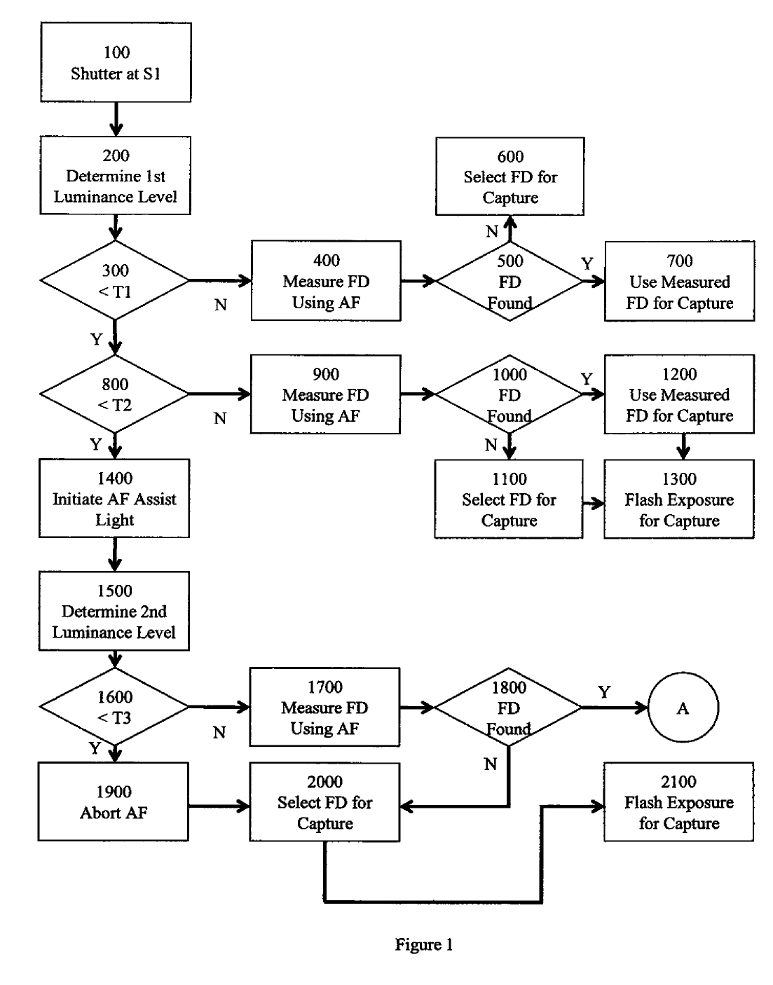

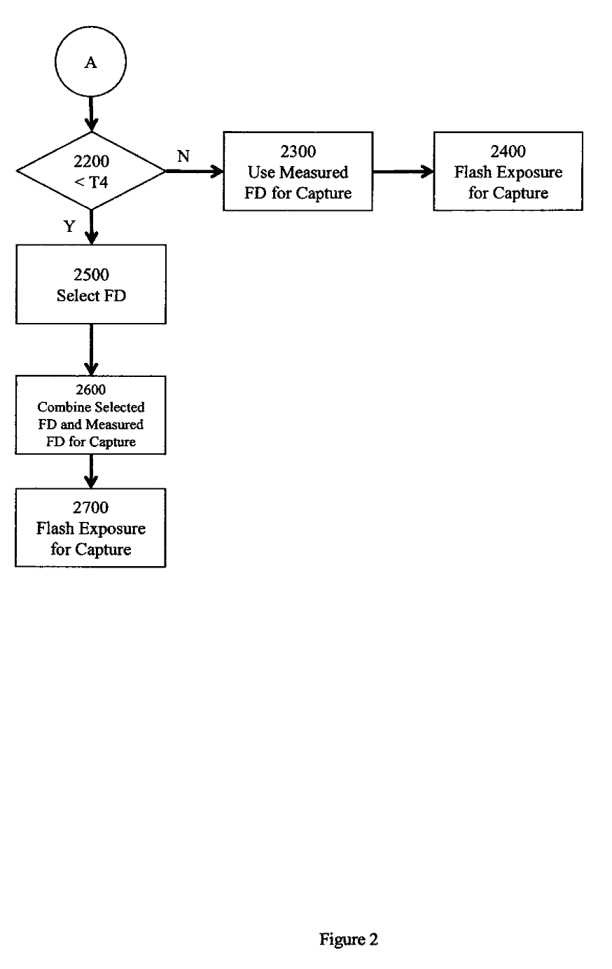

Most digital cameras calculate luminance level for a scene. For example, the H3A engine on a TI DM299 chipset may be used to provide paxellized illuminance values that can be summed to provide an estimate of a light level in a scene wherein a paxel is a group of pixels, and paxellized illuminance values are determined by measuring various locations in a scene. As illustrated in FIGS. 1 and 2, when a user presses the shutter release button to a first active position (which is commonly referred to as S1), the AF process is initiated (Step 100). In this example, prior to turning on the AF assist light, a first ambient luminance value for the scene under ambient lighting is determined (Step 200).

When this first ambient luminance value is not less than a low ambient light threshold (T1; Step 300), no flash is needed. In this case, the AF system attempts to measure camera-to-subject distance (Step 400). If a distance is found (Step 500), this measured distance is used (Step 700) if the camera operator presses the shutter release button to a second active position (which is commonly referred to as S2). In the event a camera-to-subject distance cannot be determined (Step 500), a distance is estimated using a suitable selection algorithm (Step 600). For example, if the ambient light level is high, hyperfocal is commonly used because the subject is likely to be outdoors. This estimated distance can then be used if the camera operator wishes to take a photo.

If the first ambient luminance level is below the low ambient light threshold value (T1; Step 300), a low light condition is detected and flash exposure is indicated. This light level may still be adequate for reliable TTL-AF even though it is desirable to use a flash for picture taking.

The first ambient luminance level is then compared to a second very low ambient light threshold (T2; Step 800). If this first ambient luminance value is below the second very low ambient light threshold (T2; Step 800), the AF assist light is activated (Step 1400) prior to initiation of the AF process. When the AF assist light is turned on, the AF is initiated and a second total luminance value for the scene under ambient plus AF assist light is recorded (Step 1500).

In the case that the AF assist light is not activated, i.e., the first ambient luminance value is not less than the second very low ambient light threshold (T2; Step 800), the AF result (Step 900) is accepted (Step 1200) unless AF was aborted or failed to find focus (N in Step 1000); in such cases, a set distance value is chosen for use (Step 1100) if the user initiates capture. In either event, once this focal distance is determined, the flash is activated and optionally its power level is set using the focal distance (Step 1300) in the event the camera operator wishes to take a photo. If the light level is low enough for the flash to be required, the distance is preferably chosen to be within the flash range.

When the second total luminance value is below a third AF low total reliability threshold value (T3; Step 1600), the AF assist light is extinguished and the AF process is aborted (Step 1900). Optionally, if the user presses the shutter release button to a second active position S2 to initiate capture before the AF process completes, the AF process is also aborted. If the second ambient luminance value is not less than the third AF low total reliability threshold value (T3; Step 1600), the AF process continues.

In the case that the AF assist light is activated and the AF process is aborted either due to very low total luminance (T3; Step 1600), or aborted due to user punch-through to S2, or completed without finding a camera-to-subject distance (Steps 1700 and 1800), the difference between the second total luminance value and the first ambient luminance value is used to select a rangefinder focus distance from a set of tabulated values determined using an empirical, preferably a power law, model of AF assist luminance increment versus distance (Step 2000), such as the one discussed above. This distance is chosen for use if the user initiates capture. In this case, the flash would also be used and optionally its power level is set using the focal distance (Step 2100).

In the case that the AF assist light is activated and the AF process completes to provide a primary focus distance (Step 1800), if the total luminance value is not less than a fourth AF high total reliability threshold (T4; Step 2200), typically the same as the first low light threshold T1 (but any other suitable level may be used), then the TTL-AF distance result is chosen for use if the user initiates capture (Step 2300). In this case as well, the flash would be used and optionally its power level is set using the focus distance (Step 2400).

In the case that the total luminance value is below the AF high reliability threshold (T4; Step 2200), the difference between the second total luminance level and the first ambient luminance level is again used to select a rangefinder focus distance from a set of tabulated values determined using an empirical, preferably a power law, model of AF assist luminance increment versus distance (Step 2500). The TTL-AF distance result is averaged with the rangefinder focus distance result using relative weights summing to a focus distance value dependent upon the total luminance value in a way that provides the TTL-AF result at the high reliability threshold T4 and the AF assist light based rangefinder result at the low reliability threshold T3 and intermediate values therebetween, preferably using linear interpolation in total luminance value (Step 2600). This scenario also involves the use of the flash and optionally its power level is set using the distance result (Step 2700).

A formula that may be used for determining the focus distance value by combining TTL-AF focus distance and AF assist-light-based rangefinder (RF) distance is as follows:

$$d = \{ \begin{matrix}{d}_{TTL \text{-} AF} & I \geq T 4 \\ w ( I ) {d}_{TTL \text{-} AF} + ( 1 - w ( I ) ) {d}_{RF} & T 3 < I < T 4 \\ {d}_{R F} & I \leq T 3 ,\end{matrix}$$

where the weighting function w has a value of 1 when I=T4 and zero when I=T3 and is between 0 and 1 for values of I between T3 and T4. For example, linear interpolation may be used to compute w(I) for values of I between T3 and T4 using

w(I)=(I−T3)/(T4−T3)

Of course, any other suitable formulae may be used depending on the particular imaging systems and desired threshold levels.

The invention has been described in detail with particular reference to certain preferred embodiments thereof but it will be understood that variations and modifications can be effected within the spirit and scope of the invention. Additionally, even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible.

1. A system for determining camera-to-subject distance in an imaging system under low light conditions, comprising:
a light sensor;
a rangefinder;
an autofocus (AF) assist light; and
a processor, wherein said processor activates said AF assist light when said rangefinder cannot provide an accurate estimate of said camera-to-subject distance under ambient lighting conditions, determines a second lighting level based on the use of said AF assist light, and uses the difference between an illumination level of said ambient lighting conditions and said second lighting level to determine said camera-to-subject distance.

2. The system of claim 1, wherein said processor uses a power law of the form:
d=d₀(I/I₀)^{P}
to determine said camera-to-subject distance, where d is said camera-to-subject distance, d₀ is a base focus distance, I is a measure of detected illuminance, T₀ is a measure of detected incremental illuminance, and p is a suitable power factor.

3. A camera capable of determining camera-to-subject distance under low light conditions, comprising:
a body;
a lens;
a light sensor;
autofocus (AF) circuitry, including an AF assist light;
a processor, wherein said processor activates said AF assist light when said rangefinder cannot provide an accurate estimate of said camera-to-subject distance under ambient lighting conditions, determines a second lighting level based on the use of said AF assist light, and using the difference between an illumination level of said ambient lighting conditions and said second lighting level to determine said camera-to-subject distance.

4. A method for determining distance between a subject and an imaging system under low light conditions, comprising:
determining an ambient luminance level, wherein said ambient luminance level reflects said low light conditions;
comparing said ambient luminance level to a threshold;
activating an autofocus (AF) assist light if said ambient luminance level is below said threshold;
determining a second luminance level, wherein said second luminance level reflects said low light conditions plus illumination generated by said AF assist light; and
determining said distance by taking the difference between said ambient luminance level and said second luminance level and using said difference.

5. The method of claim 4, wherein said threshold is the level below which a rangefinder in the imaging system cannot accurately determine said distance.

6. A method for determining distance between a subject and an imaging system under low light conditions, comprising:
determining an ambient luminance level, wherein said ambient luminance level reflects said low light conditions;
comparing said ambient luminance level to a first threshold;
comparing said ambient luminance level to a second threshold if said ambient luminance level is below said first threshold, wherein a flash is required for image capture if said ambient luminance level is below said first threshold;
activating an autofocus (AF) assist light if said ambient luminance level is below said second threshold; and
determining said distance under said low light conditions plus illumination generated by said AF assist light by using a difference between said ambient luminance level and a luminance level measured when said AF assist light is used.

7. A method for determining distance between a subject and an imaging system under low light conditions, comprising:
determining an ambient luminance level, wherein said ambient luminance level reflects said low light conditions;
comparing said ambient luminance level to a first threshold;
comparing said ambient luminance level to a second threshold if said ambient luminance level is below said first threshold, wherein a flash is required for image capture if said ambient luminance level is below said first threshold;
activating an autofocus (AF) assist light if said ambient luminance level is below said second threshold;
determining an enhanced luminance level, wherein said enhanced luminance level reflects said low light conditions plus illumination provided by said AF assist light;
comparing said enhanced luminance level to a third threshold;
deactivating said assist light if said enhanced luminance level if less than said third threshold;
determining said distance under said low light conditions plus illumination generated by said AF assist light by using a difference between said ambient luminance level and a luminance level measured when said AF assist light is used.

8. The method of claim 7 further comprising:
comparing said enhanced luminance level to a fourth threshold if said enhanced luminance level is greater than or equal to said third threshold; and
modifying said determined distance if said enhanced luminance level is less than said fourth threshold, wherein said modifying includes combining said determined distance with a measure from a set of tabulated values using a power law model of AF assist luminance increment versus distance.
